(19) United States
(12) Patent Application Publication
(10) Pub. No.: US 2008/0023444 A1
(43) Pub. Date: Jan. 31, 2008

(54) SUBSTRATE PROCESSING APPARATUS AND SUBSTRATE PROCESSING METHOD

(76) Inventor: Atsushi Osawa, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/779,590

(22) Filed: Jul. 18, 2007

(30) Foreign Application Priority Data
Jul. 25, 2006 (JP) 2006-201533
Mar. 23, 2007 (JP) 2007-077029

(51) Int. Cl. C23F 1/00; B44C 1/22

(52) U.S. Cl. 216/83; 156/345.15

(57) ABSTRACT

A substrate processing apparatus includes a high-speed supply system having a relatively small opening for ejecting a processing liquid through the relatively small opening to supply the processing liquid into a processing bath, and a low-speed supply system having a relatively large opening for ejecting the processing liquid through the relatively large opening to supply the processing liquid into the processing bath. While an etching process is in progress, the processing liquid is supplied through the high-speed supply system. This decreases a difference in concentration of a liquid chemical component in the processing liquid within the processing bath to improve the uniformity of the etching process. While the etching process is not in progress, on the other hand, the processing liquid is supplied through the low-speed supply system. This improves the efficiency of the replacement of the processing liquid within the processing bath.

### BACKGROUND OF THE INVENTION

1. Field of the Invention

The present invention relates to a substrate processing apparatus for performing a liquid chemical process and a rinsing process on a substrate within a single processing bath.

2. Description of the Background Art

Heretofore, there has been known a substrate processing apparatus for performing a liquid chemical process including an etching process and the like using a liquid chemical such as an aqueous solution of hydrofluoric acid and a rinsing process using deionized water upon a substrate within a single processing bath. In such a substrate processing apparatus, both of the liquid chemical and the deionized water are supplied as a processing liquid into the same processing bath. The substrate to be processed is initially subjected to the liquid chemical process by being immersed in the liquid chemical stored in the processing bath. With the substrate immersed in the liquid chemical, the deionized water is then supplied from below into the processing bath to cause the liquid chemical to be drained from above out of the processing bath, so that the entire processing liquid in the processing bath is replaced with the deionized water. Thus, the substrate is subjected to the rinsing process.

The replacement of the liquid chemical with the deionized water, for example, as the processing liquid within the processing bath (i.e., the change of the processing liquid within the processing bath from the liquid chemical to the deionized water) in the substrate processing apparatus as described above will be contemplated.

The supply of the deionized water into the processing bath with the liquid chemical stored therein causes a difference in liquid chemical component concentration between a portion of the processing liquid within the processing bath where the liquid chemical remains and a portion thereof where the deionized water is supplied. Thus, if a major surface of the substrate comes into contact with both of these portions, there is apprehension that uniformity in the liquid chemical process is impaired. To eliminate the apprehension, it is preferable to supply the deionized water at a relatively high flow rate to agitate the processing liquid within the processing bath for the purpose of decreasing the difference in the liquid chemical component in the processing liquid.

From the viewpoint of the replacement of the processing liquid within the processing bath, on the other hand, it is desired that a layer of deionized water is formed in a lower portion of the processing bath to efficiently force the liquid chemical upwardly out of the processing bath. For this reason, it is preferable to supply a large amount of deionized water and to flow the deionized water at a relatively low flow rate so as to prevent the processing liquid within the processing bath from being agitated.

For the conventional substrate processing apparatus, there are thus two contradictory technical requirements: the requirement to supply the processing liquid at a relatively high flow rate to improve the uniformity in the liquid chemical process; and the requirement to supply the processing liquid at a relatively low flow rate to improve the efficiency of the replacement of the processing liquid.

### SUMMARY OF THE INVENTION

The present invention is intended for a substrate processing apparatus including at least one processing bath for storing a processing liquid therein, the substrate processing apparatus replacing a liquid chemical and deionized water with each other for use as the processing liquid to perform a liquid chemical process and a rinsing process on a substrate within the one processing bath.

According to the present invention, the substrate processing apparatus comprises: a first supply part having a relatively small opening for ejecting the processing liquid through the relatively small opening to supply the processing liquid into the processing bath; a second supply part having a relatively large opening for ejecting the processing liquid through the relatively large opening to supply the processing liquid into the processing bath; and a controller for controlling the operation of the first and second supply parts supplying the processing liquid, the controller causing the first supply part to supply the processing liquid while the liquid chemical process is in progress, the controller causing the second supply part to supply the processing liquid while the liquid chemical process is not in progress.

While the liquid chemical process is in progress, the processing liquid is ejected through the relatively small opening. This provides the supplied processing liquid flowing at a relatively high flow rate to improve the effect of agitating the processing liquid. As a result, the substrate processing apparatus decreases a difference in concentration of a liquid chemical component in the processing liquid within the processing bath to improve the uniformity of the liquid chemical process. While the liquid chemical process is not in progress, the processing liquid is ejected through the relatively large opening. This provides the supplied processing liquid flowing at a relatively low flow rate to decrease the effect of agitating the processing liquid, thereby improving the efficiency of the replacement of the processing liquid within the processing bath.

Preferably, the substrate processing apparatus further comprises: a detection part for detecting the concentration of a liquid chemical component in the processing liquid within the processing bath; and a judgment part for judging whether the liquid chemical process is in progress or not, based on the detected concentration of the liquid chemical component.

The detection of the concentration of the liquid chemical component allows an accurate judgment to be made as to whether the liquid chemical process is in progress or not.

Preferably, the first supply part includes a plurality of nozzles divided into a plurality of groups, and the controller causes the plurality of groups to sequentially eject the processing liquid when the controller causes the first supply part to supply the processing liquid.

The ejection of the processing liquid in sequential order from the plurality of groups forms a plurality of different flows of the processing liquid to improve the effect of agitating the processing liquid.

Preferably, the substrate processing apparatus further comprises an adjustment part for adjusting the concentration of the liquid chemical component in the processing liquid being supplied into the processing bath, the adjustment part varying the concentration of the liquid chemical component in the processing liquid being supplied into the processing bath toward a target concentration within the range of from a pre-replacement concentration to the target concentration while the liquid chemical process is in progress, the target concentration being a concentration to be reached after the replacement, the pre-replacement concentration being a concentration of the liquid chemical component in the processing liquid within the processing bath prior to the replacement.

While the liquid chemical process is in progress, the concentration of the liquid chemical component in the processing liquid being supplied into the processing bath is varied toward the target concentration. This lessens the difference in concentration of the liquid chemical component in the processing liquid within the processing bath.

Preferably, the substrate processing apparatus further comprises a circulating mechanism for collecting the processing liquid used in the processing bath to supply the collected processing liquid into the processing bath while the liquid chemical process is in progress.

The processing liquid is circulated by the circulating mechanism while the liquid chemical process is in progress. This increases the amount of supply of the processing liquid to further improve the effect of agitating the processing liquid.

The present invention is also intended for a method of processing a substrate, the method replacing a liquid chemical and deionized water with each other for use as a processing liquid to perform a liquid chemical process and a rinsing process on the substrate within one processing bath.

According to another aspect of the present invention, the substrate processing apparatus comprises: a processing bath for storing a processing liquid therein; a holding part for holding the substrate within the processing bath; a processing liquid supply part for supplying one of the liquid chemical and the deionized water as the processing liquid within the processing bath; a detection part for detecting the concentration of a liquid chemical component in the processing liquid stored in the processing bath; and a controller for controlling the processing liquid supply part, the processing liquid supply part including a first ejection part having a relatively small opening for ejecting the processing liquid through the relatively small opening into the processing bath, and a second ejection part having a relatively large opening for ejecting the processing liquid through the relatively large opening into the processing bath, the controller causing the first ejection part to eject the liquid chemical when replacing the deionized water with the liquid chemical as the processing liquid within the processing bath, the controller causing the first ejection part to eject the deionized water and then causing the second ejection part to eject the deionized water after the concentration detected by the detection part is decreased to a predetermined threshold value when replacing the liquid chemical with the deionized water as the processing liquid within the processing bath.

While the state in the processing bath is substantially such that the liquid chemical process is in progress, the processing liquid is ejected through the relatively small opening. This provides the supplied processing liquid flowing at a relatively high flow rate to improve the effect of agitating the processing liquid. As a result, the substrate processing apparatus decreases a difference in concentration of the liquid chemical component in the processing liquid within the processing bath to improve the uniformity of the liquid chemical process. While the state in the processing bath is substantially such that the liquid chemical process is not in progress, the processing liquid is ejected through the relatively large opening. This provides the supplied processing liquid flowing at a relatively low flow rate to decrease the effect of agitating the processing liquid, thereby improving the efficiency of the replacement of the processing liquid within the processing bath.

Preferably, the first ejection part includes a plurality of nozzles. The plurality of nozzles included in the first ejection part are divided into a plurality of groups. The controller causes the plurality of groups to sequentially eject the processing liquid when the controller causes the first ejection part to eject the processing liquid.

The ejection of the processing liquid in sequential order from the plurality of groups forms a plurality of different flows of the processing liquid to improve the effect of agitating the processing liquid.

Preferably, the substrate processing apparatus further comprises a circulating mechanism for collecting the processing liquid used in the processing bath to supply the collected processing liquid into the processing bath.

The processing liquid is circulated by the circulating mechanism. This increases the amount of supply of the processing liquid to further improve the effect of agitating the processing liquid.

Preferably, when replacing the liquid chemical with the deionized water as the processing liquid within the processing bath, the controller causes the first ejection part to eject the deionized water, then causes the second ejection part to eject the deionized water after the concentration detected by the detection part is decreased to the predetermined threshold value, and thereafter causes the ejection of the deionized water from the first ejection part and the ejection of the deionized water from the second ejection part a predetermined number of times.

This enables the replacement of the liquid chemical with the deionized water to proceed efficiently while removing the liquid chemical remaining on the surface of the substrate by using the deionized water ejected from the first ejection part.

According to still another aspect of the present invention, the substrate processing apparatus comprises: a processing bath for storing a processing liquid therein; a holding part for holding the substrate within the processing bath; a processing liquid supply part for supplying one of the first liquid chemical, the second liquid chemical and the deionized water as the processing liquid within the processing bath; a detection part for detecting the concentration of the component of the first liquid chemical in the processing liquid stored in the processing bath; and a controller for controlling the processing liquid supply part, the processing liquid supply part including a first ejection part having a relatively small opening for ejecting the processing liquid through the relatively small opening into the processing bath, and a second ejection part having a relatively large opening for ejecting the processing liquid through the relatively large opening into the processing bath, the controller causing the first ejection part to eject the first liquid chemical when replacing the deionized water with the first liquid chemical as the processing liquid within the processing bath, the controller causing the first ejection part to eject the deionized water and then causing the second ejection part to eject the deionized water after the concentration detected by the detection part is decreased to a predetermined threshold value when replacing the first liquid chemical with the deionized water as the processing liquid within the processing bath, the controller causing the second ejection part to eject the deionized water when replacing the second liquid chemical with the deionized water as the processing liquid within the processing bath.

While the state in the processing bath is substantially such that an etching process is in progress, the processing liquid is ejected through the relatively small opening. This provides the supplied processing liquid flowing at a relatively high flow rate to improve the effect of agitating the processing liquid. As a result, the substrate processing apparatus decreases a difference in concentration of the first liquid chemical component in the processing liquid within the processing bath to improve the uniformity of the etching process. While the state in the processing bath is substantially such that the etching process is not in progress, the processing liquid is ejected through the relatively large opening. This provides the supplied processing liquid flowing at a relatively low flow rate to decrease the effect of agitating the processing liquid, thereby improving the efficiency of the replacement of the processing liquid within the processing bath.

It is therefore an object of the present invention to provide a substrate processing apparatus capable of improving the efficiency of replacement of a processing liquid while improving the uniformity of a liquid chemical process.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an example of the construction of a substrate processing apparatus according to a first preferred embodiment of the present invention;

FIG. 2 is a flow diagram showing the operation of the substrate processing apparatus according to the first preferred embodiment;

FIG. 3 shows transitions between states in a processing bath according to the first preferred embodiment;

FIG. 4 shows an example of the construction of the substrate processing apparatus according to a second preferred embodiment of the present invention;

FIG. 5 shows part of the transitions between the states in the processing bath according to the second preferred embodiment;

FIGS. 6 through 11 show examples of variations with time in the concentration of a liquid chemical component in a processing liquid being supplied;

FIG. 12 shows an example of the construction of the substrate processing apparatus according to a third preferred embodiment of the present invention;

FIG. 13 shows an example of the construction of the substrate processing apparatus according to a fourth preferred embodiment of the present invention;

FIG. 14 shows an example of the construction of the substrate processing apparatus according to a fifth preferred embodiment of the present invention;

FIG. 15 is a flow diagram showing the operation of the substrate processing apparatus according to the fifth preferred embodiment; and

FIG. 16 is a flow diagram showing the operation of supplying deionized water while doing switching between a low-speed supply system and a high-speed supply system.

### DESCRIPTION OF THE PREFERRED EMBODIMENTS

Preferred embodiments according to the present invention will now be described with reference to the drawings.

### 1. First Preferred Embodiment

<1-1. Construction>

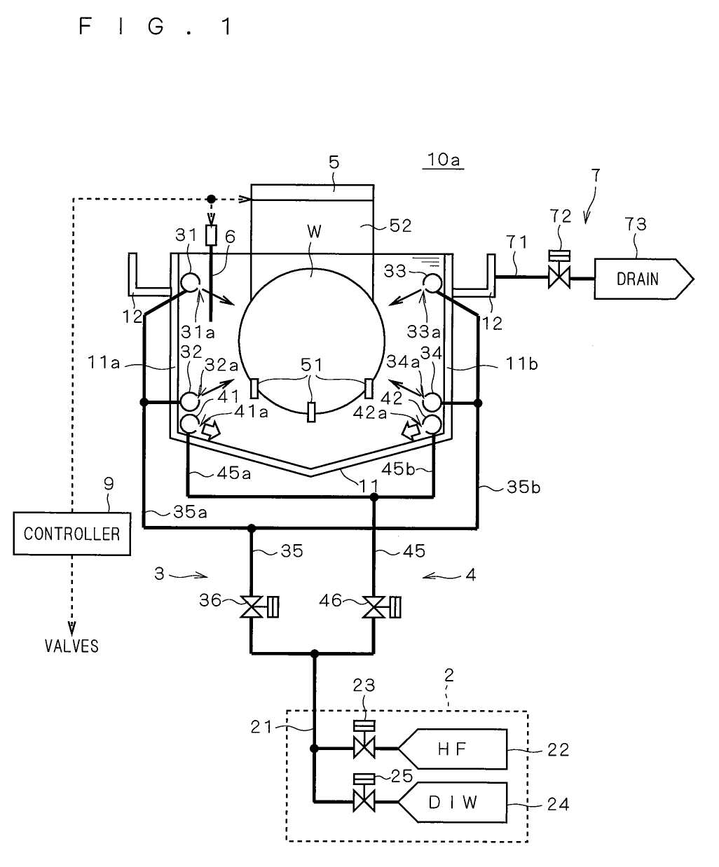

FIG. 1 schematically shows the construction of a substrate processing apparatus 10a according to a first preferred embodiment of the present invention. FIG. 1 corresponds to a vertical sectional view of the substrate processing apparatus 10a as taken along a plane parallel to a major surface of a substrate W to be processed.

This substrate processing apparatus 10a is a substrate processing apparatus of a batch type capable of performing both a liquid chemical process using a liquid chemical and a rinsing process using deionized water upon substrates W within a single processing bath. The liquid chemical and the deionized water are collectively referred to as a “processing liquid” hereinafter. In the substrate processing apparatus 10a according to the first preferred embodiment, an aqueous solution of hydrofluoric acid is used as the “liquid chemical,” and an etching process is performed as the “liquid chemical process.”

As shown in FIG. 1, the substrate processing apparatus 10a principally includes a processing bath 11 for storing the processing liquid therein, and a lifter 5 serving as a mechanism for transporting the substrates W.

The processing bath 11 is a container capable of storing the processing liquid therein, and performs a process on the major surfaces of the respective substrates W by immersing the substrates W in the processing liquid. The liquid chemical and the deionized water, which are replaced with each other in an alternating manner, are used as the processing liquid stored in the processing bath 11. The etching process is performed when the liquid chemical is used as the processing liquid, and the rinsing process is performed when the deionized water is used as the processing liquid.

The processing bath 11 has an open top portion, and allows the processing liquid to overflow through the top portion. A collection bath 12 is provided around the upper end of the processing bath 11. The processing liquid overflowing through the top portion of the processing bath 11 flows into the collection bath 12 and is received therein. A concentration sensor 6 for detecting the concentration of a liquid chemical component (i.e., the concentration of hydrofluoric acid) in the processing liquid stored in the processing bath 11 is provided in the top portion of the processing bath 11.

Substrates W are transported into and out of the processing bath 11 by the lifter 5. The lifter 5 includes holding rods 51 for holding a plurality of substrates W corresponding to one lot (or one batch) in an upright position, a lifter arm 52, and a drive part (not shown), and transports the substrates W in a vertical direction. As the drive part is operated, the lifter arm 52 and the holding rods 51 are integrally moved upwardly and downwardly. This causes the substrates W to move on a lot-by-lot basis between a first position in which the substrates W are immersed in the processing liquid within the processing bath 11 and a second position in which the substrates W are lifted out of the processing bath 11, with the substrates W held in the upright position.

The collection bath 12 of the processing bath 11 is connected to a drainage mechanism 7 for draining the processing liquid. As shown, the drainage mechanism 7 includes a pipe 71 connected to the collection bath 12, a valve 72 interposed in the pipe 71, and a drain 73 connected to the pipe 71. When the valve 72 is open, the processing liquid overflowing through the top portion of the processing bath 11 into the collection bath 12 is drained through the pipe 71 to the drain 73.

The substrate processing apparatus 10a further includes a processing liquid supply source 2 serving as a source of supply of the processing liquid, and a high-speed supply system 3 and a low-speed supply system 4 for directing the processing liquid from the processing liquid supply source 2 into the processing bath 11. The processing liquid supply source 2, the high-speed supply system 3 and the low-speed supply system 4 serve as a supply mechanism for supplying the processing liquid into the processing bath 11.

The processing liquid supply source 2 includes a hydrofluoric acid supply source 22 for supplying hydrofluoric acid (HF) serving as a liquid chemical component, a deionized water supply source 24 for supplying deionized water, and a supply pipe 21 for directing the processing liquid. The hydrofluoric acid supply source 22 is connected through a valve 23 to the supply pipe 21, and the deionized water supply source 24 is connected through a valve 25 to the supply pipe 21.

When only the valve 25 is open, the deionized water is supplied from the processing liquid supply source 2 through the supply pipe 21. When both the valve 23 and the valve 25 are open, the deionized water and the hydrofluoric acid serving as the liquid chemical component are mixed in predetermined proportions to form a liquid chemical (an aqueous solution of hydrofluoric acid) for the etching process. This liquid chemical is then supplied from the processing liquid supply source 2 through the supply pipe 21. The mixing proportions for the formation of the liquid chemical are, for example, 300 milliliters of hydrofluoric acid to 30 liters of deionized water. Thus, the concentration of the liquid chemical component (hydrofluoric acid) in the liquid chemical (the aqueous solution of hydrofluoric acid) is about 1%.

The supply pipe 21 of the processing liquid supply source 2 is divided at its downstream end into two branch pipes which in turn are connected to a pipe 35 for the high-speed supply system 3 and a pipe 45 for the low-speed supply system 4, respectively. A valve 36 and a valve 46 are interposed in the pipe 35 for the high-speed supply system 3 and the pipe 45 for the low-speed supply system 4, respectively, near their upstream ends. The opening and closing of the valves 36 and 46 allow the selection between the high-speed supply system 3 and the low-speed supply system 4. The processing liquid is supplied from the processing liquid supply source 2 through the selected supply system into the processing bath 11. Specifically, the processing liquid is supplied through the high-speed supply system 3 when the valve 36 is open, and the processing liquid is supplied through the low-speed supply system 4 when the valve 46 is open.

The high-speed supply system 3 includes four supply nozzles 31 to 34 provided within the processing bath 11 for ejecting the processing liquid to provide the processing liquid into the processing bath 11. The pipe 35 of the high-speed supply system 3 is divided into two branch pipes: a pipe 35a and a pipe 35b. Each of the pipe 35a and the pipe 35b is further divided into two branch pipes. These four pipes are connected at their downstream ends to the supply nozzles 31 to 34, respectively.

The four supply nozzles 31 to 34 are provided along two opposed wall surfaces 11a and 11b of the processing bath 11. For convenience of description, the wall surface 11a on the left-hand side in FIG. 1 is referred to hereinafter as a “left-hand wall surface”, and the wall surface 11b on the right-hand side in FIG. 1 is referred to hereinafter as a “right-hand wall surface.” The arrangement of the four supply nozzles 31 to 34 is as follows: the supply nozzle 31 is provided on an upper portion of the left-hand wall surface 11a; the supply nozzle 32 is provided on a lower portion of the left-hand wall surface 11a; the supply nozzle 33 is provided on an upper portion of the right-hand wall surface 11b; and the supply nozzle 34 is provided on a lower portion of the right-hand wall surface 11b.

The low-speed supply system 4, on the other hand, includes two supply nozzles 41 and 42 provided within the processing bath 11 for ejecting the processing liquid to provide the processing liquid into the processing bath 11. The pipe 45 of the low-speed supply system 4 is divided into two branch pipes: a pipe 45a and a pipe 45b. These two pipes are connected at their downstream ends to the supply nozzles 41 and 42, respectively. The arrangement of the two supply nozzles 41 and 42 is as follows: the supply nozzle 41 is provided on a lower portion of the left-hand wall surface 11a; and the supply nozzle 42 is provided on a lower portion of the right-hand wall surface 11b.

The supply nozzles 31, 32, 33, 34, 41 and 42 each have a cylindrical (or tubular) configuration, and include respective outer peripheral surfaces formed with ejection holes 31a, 32a, 33a, 34a, 41a and 42a which are openings. A plurality of such ejection holes are arranged along the length of each supply nozzle having the cylindrical configuration. The processing liquid provided to the inside of each supply nozzle is ejected through the plurality of ejection holes into the processing bath 11.

A comparison between the diameter of the ejection holes 31a, 32a, 33a and 34a formed in the supply nozzles 31 to 34 of the high-speed supply system 3 and the diameter of the ejection holes 41a and 42a formed in the supply nozzles 41 and 42 of the low-speed supply system 4 is as follows: the ejection holes 31a, 32a, 33a and 34a of the high-speed supply system 3 have a relatively small diameter; and the ejection holes 41a and 42a of the low-speed supply system 4 have a relatively large diameter. As an example, it is assumed that 50 substrates W having a diameter of 300 mm are spaced 5 mm apart from each other by using the lifter 5, and 58 ejection nozzles 31a, 32a, 33a, 34a, 41a and 42a are provided in each of the supply nozzles 31, 32, 33, 34, 41 and 42. In this example, the ejection holes 31a, 32a, 33a and 34a of the high-speed supply system 3 have a diameter ranging from about 0.70 mm to about 1.0 mm (e.g., 0.85 mm), and the ejection holes 41a and 42a of the low-speed supply system 4 have a diameter ranging from about 1.40 mm to about 2.20 mm (e.g., 2.00 mm).

In comparison with an instance where the processing liquid is supplied in equal amounts from the high-speed supply system 3 and the low-speed supply system 4, the above-mentioned example shows that the processing liquid supplied from the high-speed supply system 3 is relatively high in flow rate and the processing liquid supplied from the low-speed supply system 4 is relatively low in flow rate.

The direction in which the processing liquid is ejected from these supply nozzles is determined by the positions of the ejection holes formed in the outer peripheral surfaces of the respective supply nozzles. In this preferred embodiment, the supply nozzles 31 to 34 of the high-speed supply system 3 eject the processing liquid toward substantially the centers of the major surfaces of the substrates W immersed in the processing liquid, and the supply nozzles 41 and 42 of the low-speed supply system 4 eject the processing liquid along the bottom surface of the processing bath 11.

The substrate processing apparatus 10a further includes a controller 9 constructed by a microcomputer and the like for controlling the operation of the apparatus in a centralized manner. The controller 9 is electrically connected to the concentration sensor 6 and the lifter 5. Thus, the concentration of the liquid chemical component detected by the concentration sensor 6 is inputted to the controller 9, and the operation of the lifter 5 is controlled by the controller 9. The controller 9 is also connected to the valves provided in the substrate processing apparatus 10a, and is capable of controlling the opening and closing of the valves. Thus, the controller 9 controls a selection as to whether to supply the deionized water or the liquid chemical as the processing liquid from the processing liquid supply source 2 and a selection as to whether to use the high-speed supply system 3 or the low-speed supply system 4 for the supply of the processing liquid therethrough.

<1-2. Operation>

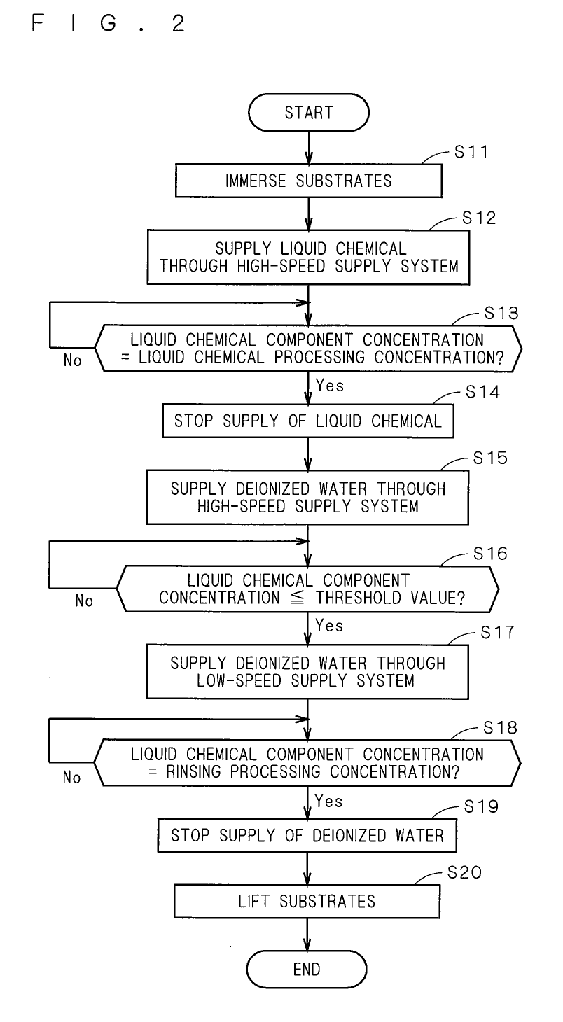

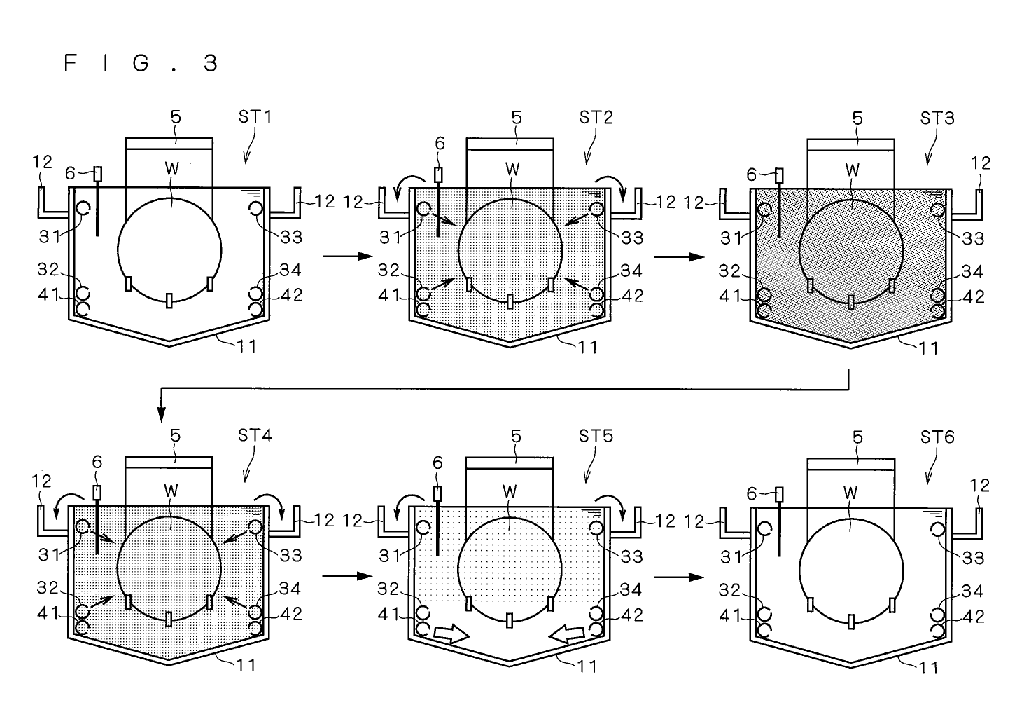

Next, the operation of the substrate processing apparatus 10a will be described. FIG. 2 is a flow diagram showing the operation of the substrate processing apparatus 10a. FIG. 3 shows transitions between states in the processing bath 11 during the operation of FIG. 2. The substrate processing apparatus 10a performs the operation shown in FIG. 2 for each lot. At the instant when this operation starts, the deionized water is stored in the processing bath 11.

First, the lifter 5 transports substrates W to the processing bath 11. Thus, the substrates W are immersed in the deionized water stored in the processing bath 11 (in Step S11 of FIG. 2; and in State ST1 of FIG. 3).

Next, for the purpose of replacing the deionized water with the liquid chemical as the processing liquid within the processing bath 11 (or changing the processing liquid within the processing bath 11 from the deionized water to the liquid chemical), the controller 9 exercises control to supply the liquid chemical through the high-speed supply system 3 into the processing bath 11. Specifically, the valve 23 and the valve 25 in the processing liquid supply source 2 and the valve 36 in the high-speed supply system 3 are opened. Thus, the liquid chemical is supplied from the processing liquid supply source 2 and is then ejected from the supply nozzles 31 to 34 of the high-speed supply system 3 into the processing bath 11. The deionized water overflowing through the top portion of the processing bath 11 because of the supply of the liquid chemical is collected by the collection bath 12, and is then drained through the drainage mechanism 7 (in Step S12 of FIG. 2; and in State ST2 of FIG. 3).

As the supply of the liquid chemical into the processing bath 11 starts, the etching process proceeds on the major surfaces of the substrates W in contact with the supplied liquid chemical. The processing liquid within the processing bath 11 is greatly agitated because the processing liquid supplied through the high-speed supply system 3 flows at a relatively high flow rate, as mentioned above. Thus, the liquid chemical supplied to the processing bath 11 and the deionized water already stored in the processing bath 11 are mixed together overall. This decreases a difference in concentration of the liquid chemical component (hydrofluoric acid) in the processing liquid within the processing bath 11 to make the concentration of the liquid chemical component uniform within the entire processing bath 11, thereby allowing the etching process to proceed uniformly on the entire major surfaces of the substrates W.

The supply nozzles 31 to 34 of the high-speed supply system 3 are substantially evenly spaced apart from each other around the substrates W immersed in the processing liquid, and supply the processing liquid toward substantially the centers of the major surfaces of the substrates W. Thus, the flows of the processing liquid ejected from the respective supply nozzles 31 to 34 interfere with each other near the centers of the major surfaces of the substrates W. This significantly improves the effect of agitating the processing liquid particularly near the centers of the major surfaces of the substrates W, that is, the effect of making the concentration of the liquid chemical component uniform.

As the supply of the liquid chemical is continued in this manner, the concentration of the liquid chemical component in the processing liquid within the processing bath 11 increases gradually. When the concentration of the liquid chemical component in the processing liquid detected by the concentration sensor 6 reaches a predetermined concentration (e.g., approximately 1%; referred to hereinafter as a “liquid chemical processing concentration”) suitable for the etching process (Yes in Step S13 of FIG. 2), the controller 9 exercises control to stop the supply of the liquid chemical into the processing bath 11 (in Step S14 of FIG. 2). After the supply of the liquid chemical is stopped, the processing bath 11 is allowed to stand as it is for a predetermined period of time. Thus, the etching process of the substrates W proceeds (in State ST3 of FIG. 3).

After a lapse of the predetermined period of time since the stop of the supply of the liquid chemical, the controller 9 exercises control to supply the deionized water through the high-speed supply system 3 into the processing bath 11 for the purpose of replacing the liquid chemical with the deionized water as the processing liquid within the processing bath 11 (or changing the processing liquid within the processing bath 11 from the liquid chemical to the deionized water). Specifically, the valve 25 of the processing liquid supply source 2 and the valve 36 of the high-speed supply system 3 are opened. Thus, the deionized water is supplied from the processing liquid supply source 2 and is then ejected from the supply nozzles 31 to 34 of the high-speed supply system 3 into the processing bath 11. The liquid chemical overflowing through the top portion of the processing bath 11 because of the supply of the deionized water is collected by the collection bath 12, and is then drained through the drainage mechanism 7 (in Step S15 of FIG. 2; and in State ST4 of FIG. 3).

Even when the supply of the deionized water into the processing bath 11 starts, the liquid chemical is present within the processing bath 11. For this reason, the etching process proceeds on the major surfaces of the substrates W in contact with the liquid chemical. Also in this case, the processing liquid within the processing bath 11 is greatly agitated because the deionized water is supplied through the high-speed supply system 3. Thus, the deionized water supplied to the processing bath 11 and the liquid chemical already stored in the processing bath 11 are mixed together overall. This decreases a difference in concentration of the liquid chemical component (hydrofluoric acid) in the processing liquid within the processing bath 11 to make the concentration of the liquid chemical component uniform within the entire processing bath 11, thereby allowing the etching process to proceed uniformly on the entire major surfaces of the substrates W.

As the supply of the deionized water is continued in this manner, the concentration of the liquid chemical component in the processing liquid within the processing bath 11 decreases gradually. When the concentration of the liquid chemical component in the processing liquid is decreased down to a given level, the etching process within the processing bath 11 does not substantially proceed. During the supply of the deionized water, the controller 9 judges whether or not the concentration of the liquid chemical component in the processing liquid detected by the concentration sensor 6 is greater than a predetermined threshold value corresponding to a concentration at which the etching process does not substantially proceed. In other words, the controller 9 makes a comparison between the concentration of the liquid chemical component and the predetermined threshold value to judge whether or not the etching process is in progress. This threshold value is previously determined by measurement and the like and stored in a memory of the controller 9 (in Step S16 of FIG. 2).

When the concentration of the liquid chemical component is not greater than the threshold value (Yes in Step S16 of FIG. 2), the controller 9 exercises control to switch the supply system for supplying the deionized water from the high-speed supply system 3 to the low-speed supply system 4. Specifically, the valve 36 of the high-speed supply system 3 is closed, and the valve 46 of the low-speed supply system 4 is opened. Thus, the deionized water is ejected from the supply nozzles 41 and 42 of the low-speed supply system 4 into the processing bath 11 (in Step S17 of FIG. 2; and in State ST5 of FIG. 3).

The effect of agitating the processing liquid within the processing bath 11 is decreased because the processing liquid supplied through the low-speed supply system 4 flows at a relatively low flow rate, as mentioned above. As the supply of the deionized water is continued in this manner, a layer of deionized water is formed in a lower portion within the processing bath 11, and the thickness of the layer of deionized water increases gradually. The layer of deionized water forces a layer of the liquid chemical present thereover through the top portion of the processing bath 11 out of the processing bath 11. This accomplishes the efficient replacement of the liquid chemical with the deionized water as the processing liquid within the processing bath 11.

When the concentration of the liquid chemical component in the processing liquid detected by the concentration sensor 6 reaches a predetermined concentration (e.g., approximately 0%; referred to hereinafter as a “rinsing processing concentration”) suitable for the rinsing process (Yes in Step S18 of FIG. 2) because of the drainage of the liquid chemical, the controller 9 exercises control to stop the supply of the deionized water into the processing bath 11 (in Step S19 of FIG. 2; and in State ST6 of FIG. 3). Thereafter, the rinsing process is performed on the substrates W within the processing bath 11 for a predetermined period of time. After the completion of the rinsing process, the lifter 5 lifts the substrates W out of the processing bath 11 (in Step S20 of FIG. 2).

As described above, the substrate processing apparatus 10a according to the first preferred embodiment includes the high-speed supply system 3 for ejecting the processing liquid through the relatively small openings to supply the processing liquid therethrough into the processing bath 11, and the low-speed supply system 4 for ejecting the processing liquid through the relatively large openings to supply the processing liquid therethrough into the processing bath 11.

The high-speed supply system 3 is used to supply the processing liquid therethrough when supplying the liquid chemical (in State ST2) and when supplying the deionized water under conditions where the concentration of the liquid chemical component is greater than the predetermined threshold value (in State ST4) (or the etching process is in progress). This improves the effect of agitating the processing liquid because of the relatively high flow rate of the supplied processing liquid to decrease the difference in concentration of the liquid chemical component in the processing liquid within the processing bath 11, thereby improving the uniformity of the etching process.

The low-speed supply system 4 is used to supply the processing liquid therethrough when supplying the deionized water under conditions where the concentration of the liquid chemical component is not greater than the predetermined threshold value (in State ST5) (or the etching process is not in progress). This decreases the effect of agitating the processing liquid because of the relatively low flow rate of the supplied processing liquid to improve the efficiency of the replacement of the processing liquid within the processing bath 11.

### 2. Second Preferred Embodiment

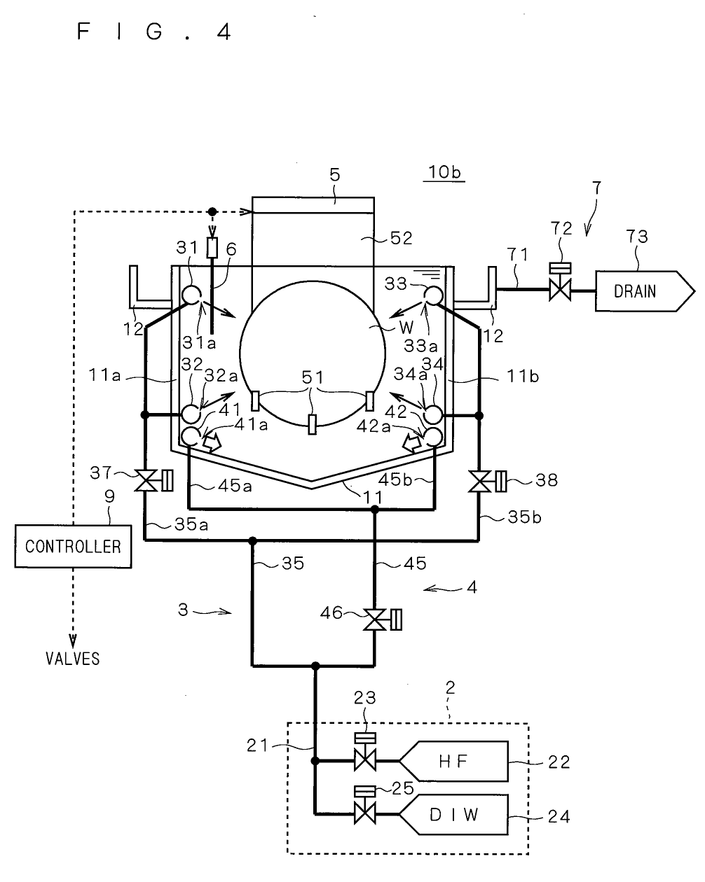

Next, a second preferred embodiment according to the present invention will be described. FIG. 4 schematically shows the construction of a substrate processing apparatus 10b according to the second preferred embodiment of the present invention. The construction of the substrate processing apparatus 10b according to the second preferred embodiment is generally similar to that of the substrate processing apparatus 10a according to the first preferred embodiment shown in FIG. 1. Differences between the substrate processing apparatus 10a and the substrate processing apparatus 10b will be principally described below.

A comparison between FIGS. 1 and 4 shows that the substrate processing apparatus 10b according to the second preferred embodiment does not include the valve 36 interposed upstream in the pipe 35 of the high-speed supply system 3, but include a valve 37 and a valve 38 interposed in the pipe 35a and the pipe 35b, respectively, which are the two downstream branch pipes of the pipe 35.

According to the second preferred embodiment, the four supply nozzles 31 to 34 of the high-speed supply system 3 are divided into the following groups: the supply nozzles 31 and 32 disposed along the left-hand wall surface 11a form a group (referred to hereinafter as a “left-hand group”); and the supply nozzles 33 and 34 disposed along the right-hand wall surface 11b form another group (referred to hereinafter as a “right-hand group”). The downstream end of the pipe 35a is connected to the left-hand group, and the downstream end of the pipe 35b is connected to the right-hand group.

Thus, the opening and closing of the valves 37 and 38 allow the selection between the left-hand group and the right-hand group. The processing liquid is ejected from the selected group into the processing bath 11. Specifically, the processing liquid is ejected from only the left-hand group when only the valve 37 is open, and the processing liquid is ejected from only the right-hand group when only the valve 38 is open. Of course, the processing liquid is supplied through the low-speed supply system 4 when both the valves 37 and 38 are closed and the valve 46 of the low-speed supply system 4 is open.

The valves 37 and 38 are also connected to the controller 9. Thus, the controller 9 controls a selection as to whether to supply the processing liquid through the left-hand group or the right-hand group.

The operation of the substrate processing apparatus 10b according to the second preferred embodiment is generally similar to that of the substrate processing apparatus 10a according to the first preferred embodiment shown in FIGS. 2 and 3. There is, however, a difference in that the controller 9 according to the second preferred embodiment controls the high-speed supply system 3 to eject the processing liquid sequentially from the groups when causing the high-speed supply system 3 to supply the processing liquid therethrough while the etching process is in progress. Specifically, the left-hand group and the right-hand group eject the processing liquid in an alternating manner therefrom when supplying the liquid chemical (in State ST2 of FIG. 3) and when supplying the deionized water under conditions where the concentration of the liquid chemical component is greater than the predetermined threshold value (in State ST4 of FIG. 3).

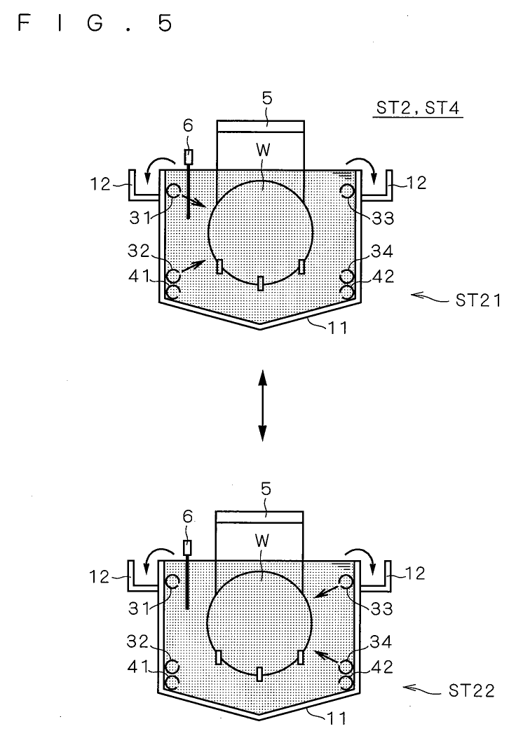

FIG. 5 shows a transition between states in the processing bath 11 in State ST2 or State ST4. State ST21 is such that the processing liquid is supplied through only the left-hand group (the supply nozzles 31 and 32) by opening the valve 37. State ST22 is such that the processing liquid is supplied through only the right-hand group (the supply nozzles 33 and 34) by opening the valve 38. In the second preferred embodiment, switching between State ST21 and State ST22 is done at predetermined time intervals.

In the second preferred embodiment as described above, the four supply nozzles 31 to 34 included in the high-speed supply system 3 are divided into two groups, and the processing liquid is ejected sequentially from the groups while the etching is in progress. This allows the formation of a plurality of different flows of the processing liquid within the processing bath 11 to further improve the effect of agitating the processing liquid within the processing bath 11. Therefore, the second preferred embodiment further improves the effect of making the concentration of the liquid chemical component in the processing liquid within the processing bath 11 uniform to enable the etching process to proceed more uniformly.

The supply nozzles disposed along the same wall surface form the same group in the second preferred embodiment. However, the supply nozzles 31 and 33 disposed in an upper portion may form a group, and the supply nozzles 32 and 34 disposed in a lower portion may form another group. Alternatively, the four supply nozzles 31 to 34 may be divided into three or four groups. As an example, when the four supply nozzles 31 to 34 are divided into four groups so that one supply nozzle belongs to one group, the supply nozzles 31, 32, 33 and 34 sequentially eject the processing liquid singularly.

### 3. Third Preferred Embodiment

Next, a third preferred embodiment according to the present invention will be described. The construction of the substrate processing apparatus according to the third preferred embodiment is generally similar to that of the substrate processing apparatus 10a according to the first preferred embodiment shown in FIG. 1. The substrate processing apparatus according to the third preferred embodiment, however, differs from the substrate processing apparatus 10a according to the first preferred embodiment in that the valve 23 inserted between the hydrofluoric acid supply source 22 and the supply pipe 21 in the processing liquid supply source 2 is a flow regulating valve capable of regulating the amount of hydrofluoric acid flowing through the position thereof. Thus, the amount of hydrofluoric acid supplied from the hydrofluoric acid supply source 22 is varied by the valve 23.

The third preferred embodiment is adapted to adjust the concentration of the liquid chemical component (hydrofluoric acid) in the liquid chemical (an aqueous solution of hydrofluoric acid) supplied from the processing liquid supply source 2 by varying the amount of hydrofluoric acid supplied from the hydrofluoric acid supply source 22 by the use of the valve 23 while supplying a fixed amount of deionized water from the deionized water supply source 24. The valve 23 is also electrically connected to the controller 9. The controller 9 controls the adjustment of the concentration of the liquid chemical component.

The operation of the substrate processing apparatus according to the third preferred embodiment is generally similar to that of the substrate processing apparatus 10a according to the first preferred embodiment shown in FIGS. 2 and 3. The third preferred embodiment, however, differs from the first preferred embodiment in increasing the concentration of the liquid chemical component in the liquid chemical being supplied in a stepwise fashion when replacing the deionized water with the liquid chemical as the processing liquid within the processing bath 11 (in State ST2 of FIG. 3).

FIG. 6 shows a variation with time in the concentration of the liquid chemical component in the liquid chemical being supplied in State ST2. In FIG. 6 (and also in the subsequent figures), the reference character D1 denotes the liquid chemical processing concentration (e.g., approximately 1%) suitable for the etching process, and D0 denotes the rinsing processing concentration (e.g., approximately 0%) suitable for the rinsing process.

As shown in FIG. 6, a liquid chemical (referred to hereinafter as a “low-concentration liquid chemical”) with a liquid chemical component concentration lower than the liquid chemical processing concentration D1 is first supplied from the processing liquid supply source 2. Specifically, the valve 25 is open and the opening of the valve 23 is adjusted in the processing liquid supply source 2 so that the deionized water and the hydrofluoric acid are mixed together in proportions of, for example, 150 milliliters of hydrofluoric acid to 30 liters of deionized water. This forms the low-concentration liquid chemical with a concentration (approximately 0.5%) which is about one-half the liquid chemical processing concentration D1. The formed low-concentration liquid chemical is supplied through the high-speed supply system 3 into the processing bath 11.

After a lapse of predetermined time t1 since the start of supply of the low-concentration liquid chemical, a liquid chemical with the liquid chemical processing concentration D1 is supplied from the processing liquid supply source 2. Specifically, the valve 25 is open and the opening of the valve 23 is adjusted in the processing liquid supply source 2 so that the deionized water and the hydrofluoric acid are mixed together in proportions of, for example, 300 milliliters of hydrofluoric acid to 30 liters of deionized water. This forms the liquid chemical with the liquid chemical processing concentration D1 (approximately 1%). The formed liquid chemical is supplied through the high-speed supply system 3 into the processing bath 11. In other words, the concentration of the liquid chemical component in the liquid chemical being supplied is varied in a stepwise fashion toward the liquid chemical processing concentration D1 which is a target concentration to be reached after the replacement of the deionized water with the liquid chemical as the processing liquid within the processing bath 11.

Varying the concentration of the liquid chemical component in the liquid chemical being supplied toward the liquid chemical processing concentration D1 while the etching process is in progress in this manner lessens the difference in concentration of the liquid chemical component between the liquid chemical supplied to the processing bath 11 and the deionized water already stored in the processing bath 11, as compared with an instance in which the liquid chemical with the liquid chemical processing concentration D1 is supplied immediately. This consequently provides the more uniform concentration of the liquid chemical component in the entire processing bath 11 to enable the etching process to proceed more uniformly on the entire major surfaces of the substrates W.

Further, during the replacement of the liquid chemical with the deionized water as the processing liquid within the processing bath 11, the etching process is in progress under conditions where the concentration of the liquid chemical component is greater than the predetermined threshold value (in State ST4 of FIG. 3) in the third preferred embodiment. Thus, the deionized water is not immediately supplied into the processing bath 11, but the low-concentration liquid chemical is supplied prior to the supply of the deionized water.

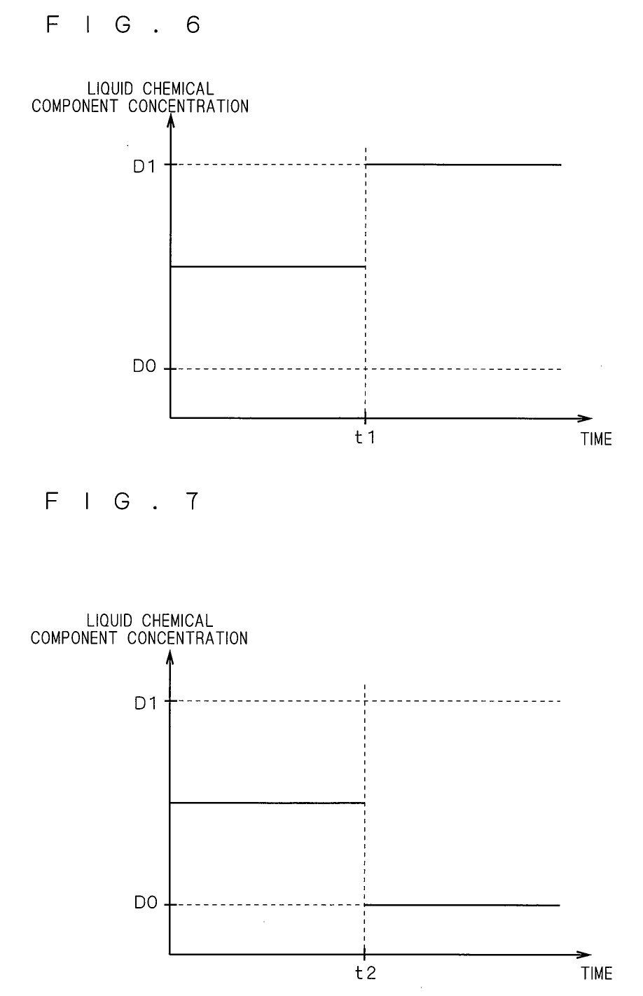

FIG. 7 shows a variation with time in the concentration of the liquid chemical component in the liquid chemical being supplied in State ST4. As shown in FIG. 7, a low-concentration liquid chemical is first supplied into the processing bath 11. After a lapse of predetermined time t2, the valve 23 is closed, and the deionized water (the processing liquid with the rinsing processing concentration D0) is supplied into the processing bath 11. In other words, the concentration of the liquid chemical component in the liquid chemical being supplied is varied in a stepwise fashion toward the rinsing processing concentration D0 which is a target concentration to be reached after the replacement of the processing liquid within the processing bath 11 also in this case. This also lessens the difference in concentration of the liquid chemical component between the processing liquid supplied to the processing bath 11 and the liquid chemical already stored in the processing bath 11 in the step of the start of the supply to enable the etching process to proceed more uniformly.

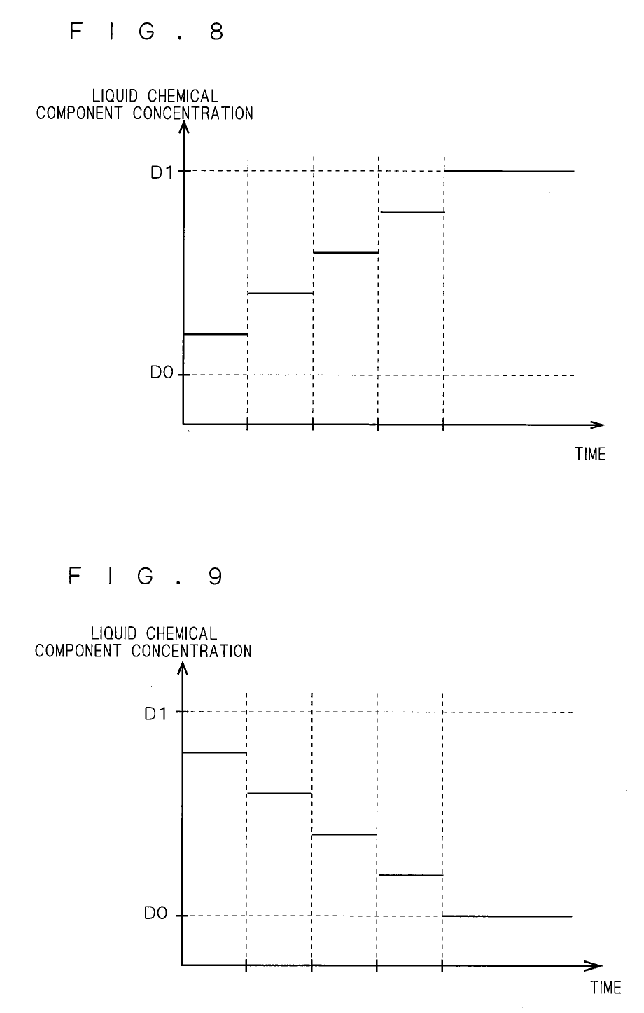

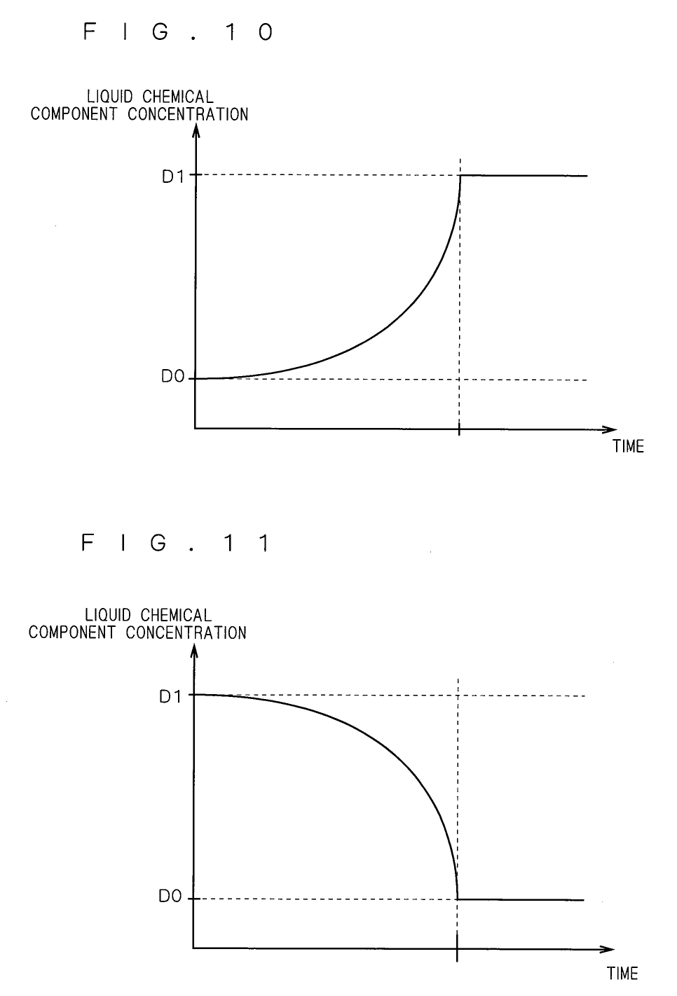

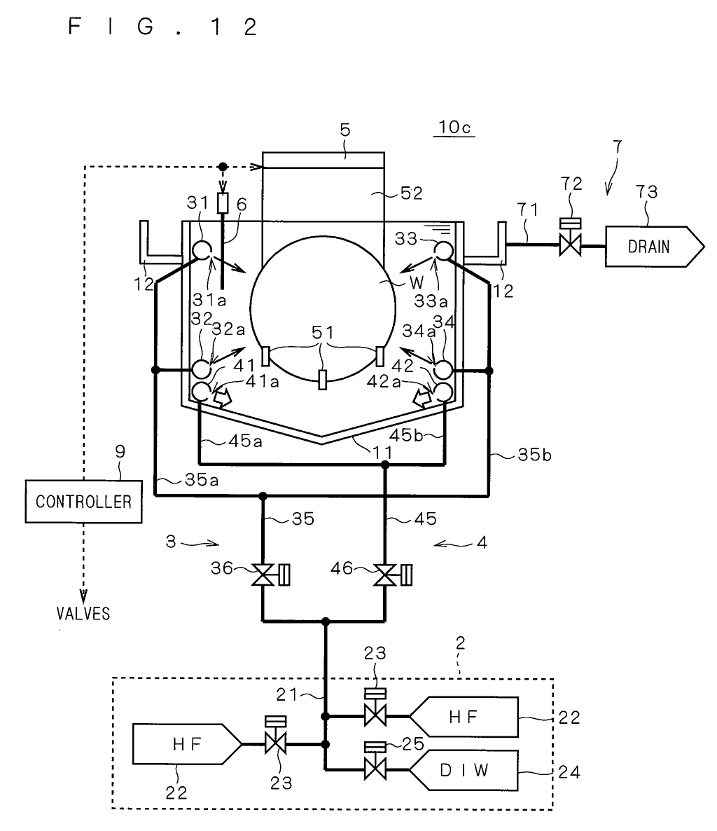

Although the concentration of the liquid chemical component in the processing liquid is described above as varied in two steps, the concentration of the liquid chemical component may be varied in three or more steps, as illustrated in FIGS. 8 and 9. Also, the concentration of the liquid chemical component may be varied continuously (or steplessly), as illustrated in FIGS. 10 and 11.

In either of the above-mentioned cases, the concentration of the liquid chemical component in the processing liquid being supplied is varied toward the target concentration within the range of (from D0 to D1) from a pre-replacement concentration of the liquid chemical component in the processing liquid within the processing bath 11 prior to the replacement to the target concentration to be reached after the replacement. Specifically, during the replacement of the deionized water with the liquid chemical as the processing liquid within the processing bath 11 (FIGS. 6, 8 and 10), the concentration of the liquid chemical component in the processing liquid being supplied is varied toward the liquid chemical processing concentration D1 within the range of from the rinsing processing concentration D0 (the pre-replacement concentration prior to the replacement) to the liquid chemical processing concentration D1 (the target concentration to be reached after the replacement). On the other hand, during the replacement of the liquid chemical with the deionized water as the processing liquid within the processing bath 11 (FIGS. 7, 9 and 11), the concentration of the liquid chemical component in the processing liquid being supplied is varied toward the rinsing processing concentration D0 within the range of from the liquid chemical processing concentration D1 (the pre-replacement concentration prior to the replacement) to the rinsing processing concentration D0 (the target concentration to be reached after the replacement). The increase in the number of steps in which the concentration of the liquid chemical component in the processing liquid being supplied is varied or the continuous (or stepless) variation in the concentration of the liquid chemical component in the processing liquid being supplied further improves the effect of lessening the difference in concentration of the liquid chemical component within the processing bath 11 to enable the etching process to proceed more uniformly.

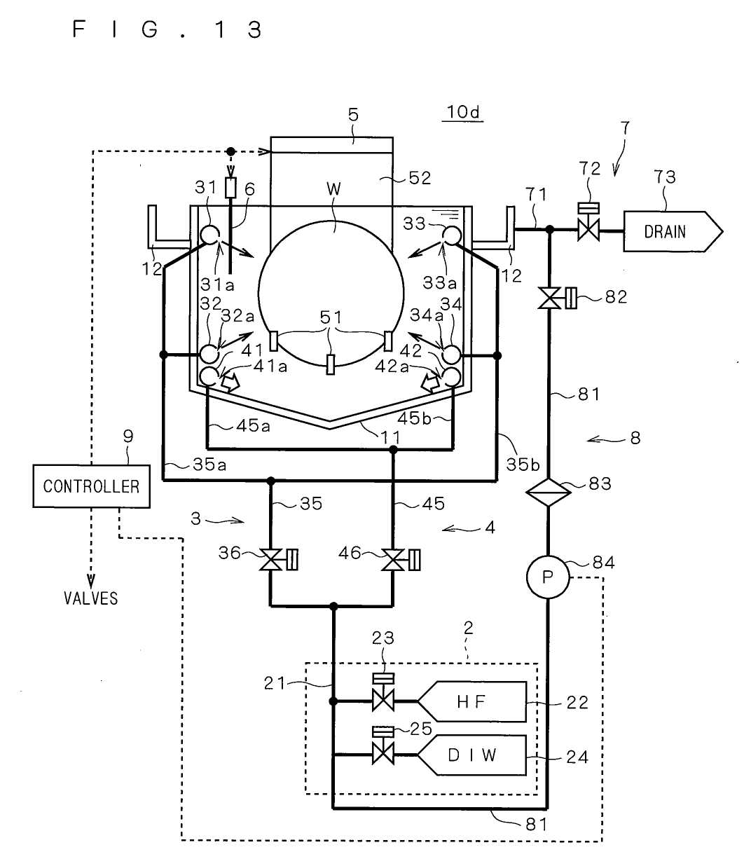

Although the flow regulating valve is used to adjust the concentration of the liquid chemical component in the third preferred embodiment, a plurality of combinations of hydrofluoric acid supply sources 22 and valves 23 for performing a simple opening and closing operation may be provided, the combinations being equal in number to the steps in which the concentration is varied. This allows only the simple opening and closing of the valves 23 to accomplish the adjustment of the concentration of the liquid chemical component, thereby facilitating the control of the adjustment of the concentration. As an example, a substrate processing apparatus 10c shown in FIG. 12, which includes two combinations of hydrofluoric acid supply sources 22 and valves 23 for performing a simple opening and closing operation, is capable of varying the concentration of the liquid chemical component in the processing liquid being supplied in two steps. Specifically, one of the valves 23 is opened for the supply of the low-concentration liquid chemical, and both of the two valves 23 are opened for the supply of the liquid chemical with the liquid chemical processing concentration D1.

### Fourth Preferred Embodiment

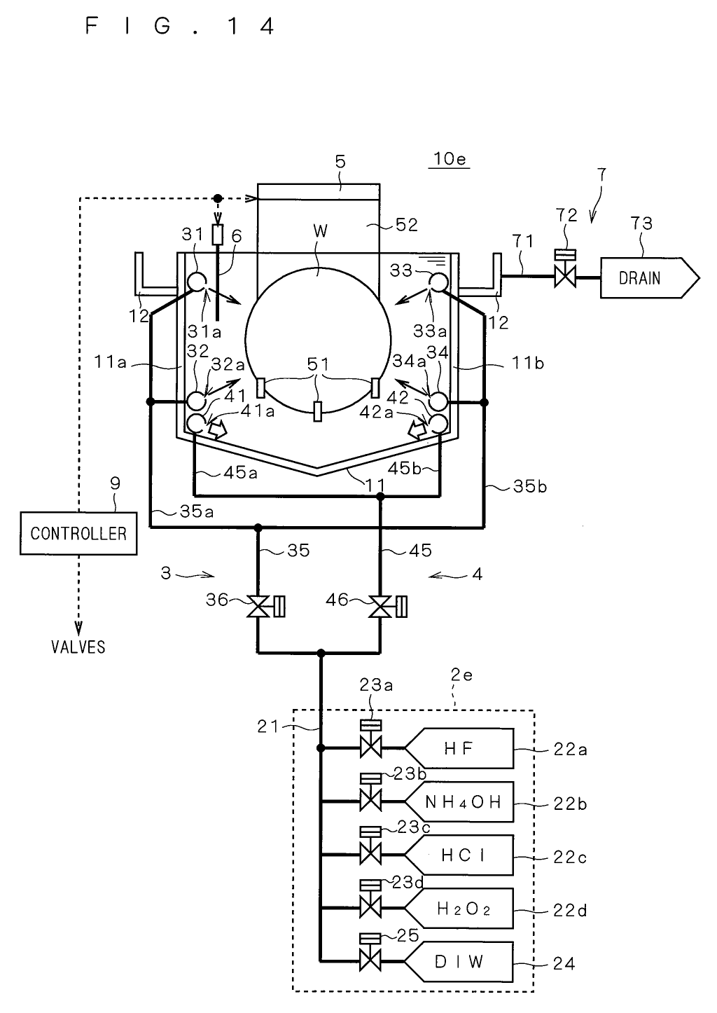

Next, a fourth preferred embodiment according to the present invention will be described. FIG. 13 schematically shows the construction of a substrate processing apparatus 10d according to the fourth preferred embodiment of the present invention. The substrate processing apparatus 10d according to the fourth preferred embodiment further includes a circulating mechanism 8 for collecting the processing liquid used in the processing bath to supply the collected processing liquid into the processing bath, in addition to components similar to those of the substrate processing apparatus 10a according to the first preferred embodiment shown in FIG. 1.

The circulating mechanism 8 includes a collection pipe 81 for directing the collected processing liquid therethrough. The collection pipe 81 has an upstream end connected through the pipe 71 to the collection bath 12, and a downstream end connected to the supply pipe 21 of the processing liquid supply source 2. The collection pipe 81 is provided with a valve 82, a filter 83 for purifying the processing liquid passing therethrough, and a pump 84 for delivering the processing liquid, which are arranged in the order named in a downstream direction.

The valve 82 is provided near the upstream end of the collection pipe 81. When the valve 82 is open, the processing liquid used in the processing bath 11 and stored in the collection bath 12 is directed and collected by the circulating mechanism 8. When the valve 82 is closed and the valve 72 of the drainage mechanism 7 is open, the processing liquid stored in the collection bath 12 is drained to the drain 73.

The pump 84 is provided to deliver the processing liquid in the collection pipe 81. As the pump 84 is driven with the valve 82 open, the collected processing liquid is delivered to the supply pipe 21 of the processing liquid supply source 2. Then, the collected processing liquid is mixed with the processing liquid newly supplied from the processing liquid supply source 2, and is supplied again into the processing bath 11. A foreign substance contained in the collected processing liquid is removed when the processing liquid passes through the filter 83.

The valve 82 and the pump 84 are electrically connected to the controller 9. Thus, the operation of the circulating mechanism 8 circulating the used processing liquid is also controlled by the controller 9.

The operation of the substrate processing apparatus 10d according to the fourth preferred embodiment is generally similar to that of the substrate processing apparatus 10a according to the first preferred embodiment shown in FIGS. 2 and 3. There is, however, a difference in that the circulating mechanism 8 is activated in the fourth preferred embodiment when the processing liquid is supplied to the high-speed supply system 3 while the etching process is in progress. Specifically, the fourth preferred embodiment is adapted to open the valve 82 and drive the pump 84 to thereby circulate the used processing liquid when supplying the liquid chemical (in State ST2 of FIG. 3) and when supplying the deionized water under conditions where the concentration of the liquid chemical component is greater than the predetermined threshold value (in State ST4 of FIG. 3).

Thus circulating the processing liquid by using the circulating mechanism while the etching process is in progress causes the collected processing liquid to be supplied into the processing bath 11 together with the processing liquid newly supplied from the processing liquid supply source 2, thereby increasing the amount of processing liquid supplied to the processing bath 11. This further improves the effect of agitating the processing liquid within the processing bath 11 because of the higher flow rate of the supplied processing liquid from the high-speed supply system 3 to enable the etching process to proceed more uniformly.

For example, during the replacement of the deionized water with the liquid chemical as the processing liquid within the processing bath 11 (in State ST2), the concentration of the liquid chemical component in the collected processing liquid is lower than the concentration (the liquid chemical processing concentration) of the liquid chemical supplied from the processing liquid supply source 2. Since a mixture of the collected processing liquid and the liquid chemical supplied from the processing liquid supply source 2 is supplied to the processing bath 11, the processing liquid supplied to the processing bath 11 has a concentration lower than the liquid chemical processing concentration. Continuing the supply of this processing liquid gradually increases the concentration of the liquid chemical component in the processing liquid within the processing bath 11 to accordingly gradually increase the concentration of the liquid chemical component in the collected processing liquid. Thus, the concentration of the liquid chemical component in the processing liquid being supplied to the processing bath 11 increases continuously toward the liquid chemical processing concentration.

In contrast to this, during the replacement of the liquid chemical with the deionized water as the processing liquid within the processing bath 11 (in State ST4), the concentration of the liquid chemical component in the collected processing liquid is higher than the concentration (the rinsing processing concentration) of the deionized water supplied from the processing liquid supply source 2. Thus, the processing liquid supplied to the processing bath 11 has a concentration lower than the rinsing processing concentration. Continuing the supply of this processing liquid gradually decreases the concentration of the liquid chemical component in the processing liquid within the processing bath 11 to accordingly gradually decrease the concentration of the liquid chemical component in the collected processing liquid. Thus, the concentration of the liquid chemical component in the processing liquid being supplied to the processing bath 11 decreases continuously toward the rinsing processing concentration. That is, the substrate processing apparatus 10d according to the fourth preferred embodiment produces effects similar to those of the third preferred embodiment to enable the etching process to proceed more uniformly.

### 5. Fifth Preferred Embodiment

<5-1. Construction>

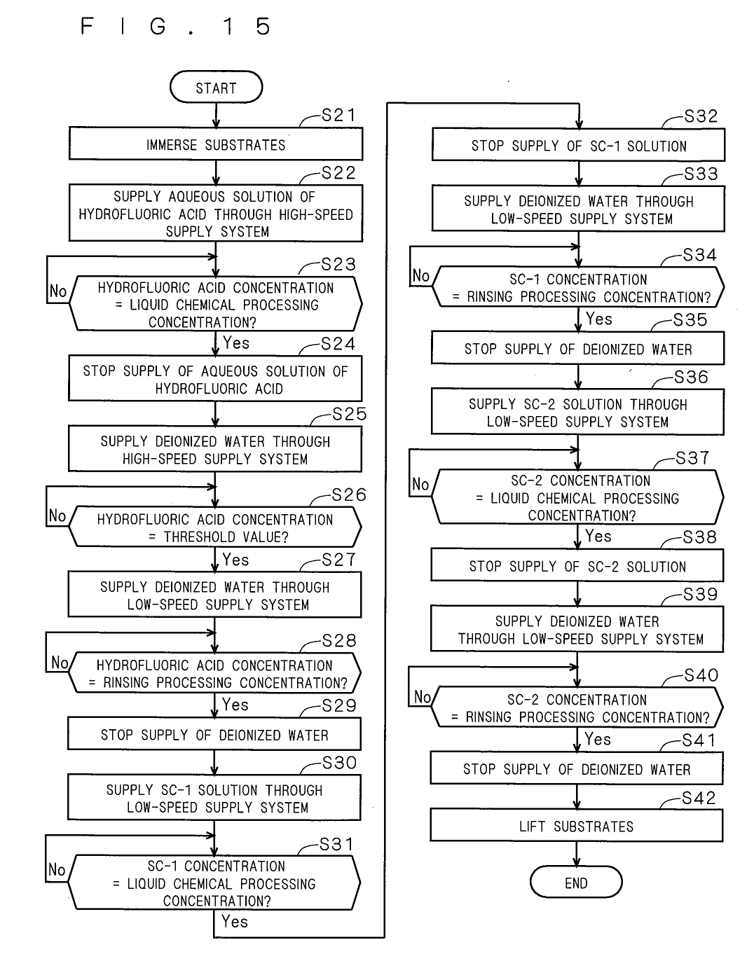

Next, a fifth preferred embodiment according to the present invention will be described. FIG. 14 schematically shows the construction of a substrate processing apparatus 10e according to the fifth preferred embodiment of the present invention. The construction of the substrate processing apparatus 10e according to the fifth preferred embodiment is generally similar to that of the substrate processing apparatus 10a according to the first preferred embodiment except for the internal construction of a processing liquid supply source 2e. The construction of the processing liquid supply source 2e will be principally described below. Other parts in FIG. 14 are designated by reference numerals and characters identical with those in FIG. 1, and will not be described.

The processing liquid supply source 2e of the substrate processing apparatus 10e includes a hydrofluoric acid supply source 22a, an ammonium hydroxide supply source 22b, a hydrochloric acid supply source 22c, and a hydrogen peroxide supply source 22d which serve as sources of supply of liquid chemical components. The processing liquid supply source 2e further includes the deionized water supply source 24 for supplying deionized water, and the supply pipe 21 for directing the processing liquid. The hydrofluoric acid supply source 22a, the ammonium hydroxide supply source 22b, the hydrochloric acid supply source 22c, the hydrogen peroxide supply source 22d and the deionized water supply source 24 are connected to the supply pipe 21 through valves 23a, 23b, 23c, 23d and 25, respectively.

When the valves 23b to 23d are closed and the valves 23a and 25 are open in such a processing liquid supply source 2e, hydrofluoric acid from the hydrofluoric acid supply source 22a and deionized water from the deionized water supply source 24 are mixed in predetermined proportions to form an aqueous solution of hydrofluoric acid as a liquid chemical for the etching process. The formed aqueous solution of hydrofluoric acid is then supplied through the supply pipe 21 to the high-speed supply system 3 and the low-speed supply system 4.

When the valves 23a and 23c are closed and the valves 23b, 23d and 25 are open in such a processing liquid supply source 2e, ammonium hydroxide from the ammonium hydroxide supply source 22b, hydrogen peroxide from the hydrogen peroxide supply source 22d, and deionized water from the deionized water supply source 24 are mixed in predetermined proportions to form an SC-1 (standard cleaning 1; NH₄OH—H₂O₂—H₂O) solution as a liquid chemical for a liquid chemical cleaning process (non-etching process). The formed SC-1 solution is then supplied through the supply pipe 21 to the high-speed supply system 3 and the low-speed supply system 4.

When the valves 23a and 23b are closed and the valves 23c, 23d and 25 are open in such a processing liquid supply source 2e, hydrochloric acid from the hydrochloric acid supply source 22c, hydrogen peroxide from the hydrogen peroxide supply source 22d, and deionized water from the deionized water supply source 24 are mixed in predetermined proportions to form an SC-2 (standard cleaning 2; HC₁—H₂O₂—H₂O) solution as a liquid chemical for a liquid chemical cleaning process (non-etching process). The formed SC-2 solution is then supplied through the supply pipe 21 to the high-speed supply system 3 and the low-speed supply system 4.

When the valves 23a to 23d are closed and the valve 25 is open in such a processing liquid supply source 2e, deionized water from the deionized water supply source 24 is supplied through the supply pipe 21 to the high-speed supply system 3 and the low-speed supply system 4. It should be noted that the concentration sensor 6 according to the fifth preferred embodiment is capable of detecting not only the concentration of the hydrofluoric acid in the processing liquid stored in the processing bath 11 but also the concentration of SC-1 and the concentration of SC-2.

<5-2. Operation>

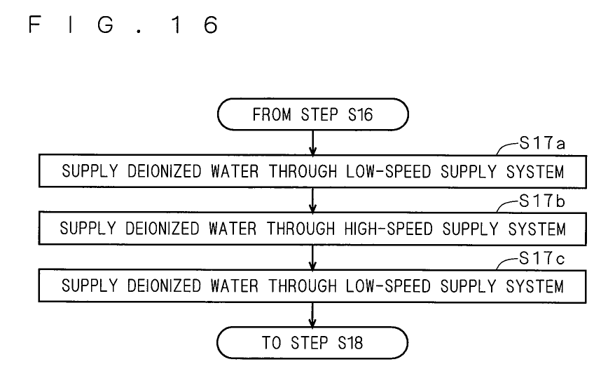

Next, the operation of the substrate processing apparatus 10e according to the fifth preferred embodiment will be described, with reference to the flow diagram of FIG. 15. The controller 9 controls the opening and closing of the valves 23a to 23d, 25, 36, 46 and 72 and the operation of the lifter 5 while receiving measurements from the concentration sensor 6, whereby the operation to be described below proceeds.

The first step of the processing of substrates W in the substrate processing apparatus 10e is to place the substrates W corresponding to one lot (or one batch) on the holding rods 51 of the lifter 5. The deionized water is previously stored in the processing bath 11 of the substrate processing apparatus 10e. The substrate processing apparatus 10e causes the lifter 5 to move down, thereby immersing the substrates W in the deionized water stored in the processing bath 11 (in Step S21).

Next, the substrate processing apparatus 10e opens the valves 23a, 25 and 36, with the valves 23b to 23d and 46 closed, to supply the aqueous solution of hydrofluoric acid from the processing liquid supply source 2e through the high-speed supply system 3 into the processing bath 11. The aqueous solution of hydrofluoric acid is ejected from the supply nozzles 31 to 34 of the high-speed supply system 3 into the processing bath 11. The processing liquid overflowing through the top portion of the processing bath 11 because of the supply of the aqueous solution of hydrofluoric acid is collected by the collection bath 12, and is then drained through the drainage mechanism 7 (in Step S22).

As the supply of the aqueous solution of hydrofluoric acid into the processing bath 11 starts, the etching process proceeds on the major surfaces of the substrates W in contact with the supplied aqueous solution of hydrofluoric acid. The processing liquid within the processing bath 11 is greatly agitated because the aqueous solution of hydrofluoric acid ejected from the supply nozzles 31 to 34 flows at a relatively high flow rate. Thus, the aqueous solution of hydrofluoric acid supplied to the processing bath 11 and the deionized water already stored in the processing bath 11 are mixed together overall. This decreases a difference in concentration of hydrofluoric acid in the processing liquid within the processing bath 11 to make the concentration of the hydrofluoric acid uniform within the entire processing bath 11, thereby allowing the etching process to proceed uniformly on the entire major surfaces of the substrates W.

The supply nozzles 31 to 34 of the high-speed supply system 3 are substantially evenly spaced apart from each other around the substrates W immersed in the processing liquid, and supply the aqueous solution of hydrofluoric acid toward substantially the centers of the major surfaces of the substrates W. Thus, the flows of the aqueous solution of hydrofluoric acid ejected from the respective supply nozzles 31 to 34 interfere with each other near the centers of the major surfaces of the substrates W. This significantly improves the effect of agitating the processing liquid particularly near the centers of the major surfaces of the substrates W, that is, the effect of making the concentration of the hydrofluoric acid uniform.

As the supply of the aqueous solution of hydrofluoric acid is continued in this manner, the concentration of the hydrofluoric acid in the processing liquid within the processing bath 11 increases gradually. When the concentration of the hydrofluoric acid in the processing liquid detected by the concentration sensor 6 reaches a predetermined concentration (the liquid chemical processing concentration) suitable for the etching process (Yes in Step S23), the substrate processing apparatus 10e closes the valves 23a, 25 and 36 to stop the supply of the aqueous solution of hydrofluoric acid into the processing bath 11 (in Step S24). After the supply of the aqueous solution of hydrofluoric acid is stopped, the substrate processing apparatus 10e allows the interior of the processing bath 11 to stand as it is for a predetermined period of time, thereby causing the etching process of the substrates W to proceed.

After a lapse of the predetermined period of time since the stop of the supply of the aqueous solution of hydrofluoric acid, the substrate processing apparatus 10e opens the valves 25 and 36, with the valves 23a to 23d and 46 closed, to supply the deionized water from the processing liquid supply source 2e through the high-speed supply system 3 into the processing bath 11. The deionized water is ejected from the supply nozzles 31 to 34 of the high-speed supply system 3 into the processing bath 11. The processing liquid overflowing through the top portion of the processing bath 11 because of the supply of the deionized water is collected by the collection bath 12, and is then drained through the drainage mechanism 7 (in Step S25).

Even when the supply of the deionized water into the processing bath 11 starts, a hydrofluoric acid component is present within the processing bath 11. For this reason, the etching process proceeds on the major surfaces of the substrates W in contact with the hydrofluoric acid component. Also in this case, the processing liquid within the processing bath 11 is greatly agitated because the deionized water is ejected from the supply nozzles 31 to 34 of the high-speed supply system 3. Thus, the deionized water supplied to the processing bath 11 and the aqueous solution of hydrofluoric acid already stored in the processing bath 11 are mixed together overall. This decreases a difference in concentration of the hydrofluoric acid in the processing liquid within the processing bath 11 to make the concentration of the hydrofluoric acid uniform within the entire processing bath 11, thereby allowing the etching process to proceed uniformly on the entire major surfaces of the substrates W.

As the supply of the deionized water is continued in this manner, the concentration of the hydrofluoric acid in the processing liquid within the processing bath 11 decreases gradually. When the concentration of the hydrofluoric acid in the processing liquid is decreased down to a given level, the etching process within the processing bath 11 does not substantially proceed. During the supply of the deionized water, the controller 9 of the substrate processing apparatus 10e observes whether or not a measurement from the concentration sensor 6 is greater than a predetermined threshold value at which the etching process does not substantially proceed, to judge whether or not the etching process is in progress (in Step S26). This above-mentioned threshold value is previously determined by measurement and the like and stored in a memory of the controller 9.

When the concentration of the hydrofluoric acid is not greater than the threshold value (Yes in Step S26), the substrate processing apparatus 10e closes the valve 36 and opens the valve 46 to switch the supply system for supplying the deionized water from the high-speed supply system 3 to the low-speed supply system 4. Specifically, the substrate processing apparatus 10e stops the supply of the deionized water through the supply nozzles 31 to 34, and causes the supply nozzles 41 and 42 to eject the deionized water into the processing bath 11 (in Step S27).

The effect of agitating the processing liquid within the processing bath 11 is decreased because the processing liquid ejected from the supply nozzles 41 and 42 of the low-speed supply system 4 flows at a relatively low flow rate. As the supply of the deionized water is continued in this manner, a layer of deionized water is formed in a lower portion within the processing bath 11, and the thickness of the layer of deionized water increases gradually. The layer of deionized water forces the hydrofluoric acid component present thereover through the top portion of the processing bath 11 out of the processing bath 11. This accomplishes the efficient replacement of the hydrofluoric acid component within the processing bath 11 with the deionized water.

When the concentration of the hydrofluoric acid component in the processing liquid detected by the concentration sensor 6 reaches a predetermined concentration (the rinsing processing concentration) (Yes in Step S28), the substrate processing apparatus 10e closes the valves 25 and 46 to stop the supply of the deionized water into the processing bath 11 (in Step S29). This completes the rinsing process of the substrates W.

Subsequently, the substrate processing apparatus 10e opens the valves 23b, 23d, 25 and 46, with the valves 23a, 23c and 36 closed, to supply the SC-1 solution from the processing liquid supply source 2e through the low-speed supply system 4 into the processing bath 11. The SC-1 solution is ejected from the supply nozzles 41 and 42 of the low-speed supply system 4 into the processing bath 11. The processing liquid overflowing through the top portion of the processing bath 11 because of the supply of the SC-1 solution is collected by the collection bath 12, and is then drained through the drainage mechanism 7 (in Step S30).

Since the SC-1 solution ejected from the supply nozzles 41 and 42 flows at a relatively low flow rate, the processing liquid within the processing bath 11 is not greatly agitated, but a layer of SC-1 solution is formed in a lower portion within the processing bath 11. As the supply of the SC-1 solution is continued, the thickness of the layer of SC-1 solution increases gradually. The layer of SC-1 solution forces the deionized water through the top portion of the processing bath 11 out of the processing bath 11, and the SC-1 solution is stored within the processing bath 11. This accomplishes the efficient replacement of the deionized water with the SC-1 solution as the processing liquid within the processing bath 11.

When the concentration of the SC-1 in the processing liquid detected by the concentration sensor 6 reaches a predetermined concentration (the liquid chemical processing concentration) suitable for the liquid chemical cleaning process (Yes in Step S31), the substrate processing apparatus 10e closes the valves 23b, 23d and 25 to stop the supply of the SC-1 solution into the processing bath 11 (in Step S32). After the supply of the SC-1 solution is stopped, the substrate processing apparatus 10e allows the interior of the processing bath 11 to stand as it is for a predetermined period of time, thereby causing the liquid chemical cleaning process of the substrates W to proceed.

After a lapse of the predetermined period of time since the stop of the supply of the SC-1 solution, the substrate processing apparatus 10e then opens the valves 25 and 46, with the valves 23a to 23d and 36 closed, to supply the deionized water from the processing liquid supply source 2e through the low-speed supply system 4 into the processing bath 11. The deionized water is ejected from the supply nozzles 41 and 42 of the low-speed supply system 4 into the processing bath 11. The processing liquid overflowing through the top portion of the processing bath 11 because of the supply of the deionized water is collected by the collection bath 12, and is then drained through the drainage mechanism 7 (in Step S33).

Since the deionized water ejected from the supply nozzles 41 and 42 flows at a relatively low flow rate, the processing liquid within the processing bath 11 is not greatly agitated, but a layer of deionized water is formed in a lower portion within the processing bath 11. As the supply of the deionized water is continued, the thickness of the layer of deionized water increases gradually. The layer of deionized water forces the SC-1 solution through the top portion of the processing bath 11 out of the processing bath 11, and the deionized water is stored within the processing bath 11. This accomplishes the efficient replacement of the SC-1 solution with the deionized water as the processing liquid within the processing bath 11.

When the concentration of the SC-1 in the processing liquid detected by the concentration sensor 6 reaches a predetermined concentration (the rinsing processing concentration) (Yes in Step S34), the substrate processing apparatus 10e closes the valves 25 and 46 to stop the supply of the deionized water into the processing bath 11 (in Step S35). This completes the rinsing process of the substrates W.

Subsequently, the substrate processing apparatus 10e opens the valves 23c, 23d, 25 and 46, with the valves 23a, 23b and 36 closed, to supply the SC-2 solution from the processing liquid supply source 2e through the low-speed supply system 4 into the processing bath 11. The SC-2 solution is ejected from the supply nozzles 41 and 42 of the low-speed supply system 4 into the processing bath 11. The processing liquid overflowing through the top portion of the processing bath 11 because of the supply of the SC-2 solution is collected by the collection bath 12, and is then drained through the drainage mechanism 7 (in Step S36).

Since the SC-2 solution ejected from the supply nozzles 41 and 42 flows at a relatively low flow rate, the processing liquid within the processing bath 11 is not greatly agitated, but a layer of SC-2 solution is formed in a lower portion within the processing bath 11. As the supply of the SC-2 solution is continued, the thickness of the layer of SC-2 solution increases gradually. The layer of SC-2 solution forces the deionized water through the top portion of the processing bath 11 out of the processing bath 11, and the SC-2 solution is stored within the processing bath 11. This accomplishes the efficient replacement of the deionized water with the SC-2 solution as the processing liquid within the processing bath 11.

When the concentration of the SC-2 in the processing liquid detected by the concentration sensor 6 reaches a predetermined concentration (the liquid chemical processing concentration) suitable for the liquid chemical cleaning process (Yes in Step S37), the substrate processing apparatus 10e closes the valves 23c, 23d and 25 to stop the supply of the SC-2 solution into the processing bath 11 (in Step S38). After the supply of the SC-2 solution is stopped, the substrate processing apparatus 10e allows the interior of the processing bath 11 to stand as it is for a predetermined period of time, thereby causing the liquid chemical cleaning process of the substrates W to proceed.

After a lapse of the predetermined period of time since the stop of the supply of the SC-2 solution, the substrate processing apparatus 10e opens the valves 25 and 46, with the valves 23a to 23d and 36 closed, to supply the deionized water from the processing liquid supply source 2e through the low-speed supply system 4 into the processing bath 11. The deionized water is ejected from the supply nozzles 41 and 42 of the low-speed supply system 4 into the processing bath 11. The processing liquid overflowing through the top portion of the processing bath 11 because of the supply of the deionized water is collected by the collection bath 12, and is then drained through the drainage mechanism 7 (in Step S39).

Since the deionized water ejected from the supply nozzles 41 and 42 flows at a relatively low flow rate, the processing liquid within the processing bath 11 is not greatly agitated, but a layer of deionized water is formed in a lower portion within the processing bath 11. As the supply of the deionized water is continued, the thickness of the layer of deionized water increases gradually. The layer of deionized water forces the SC-2 solution through the top portion of the processing bath 11 out of the processing bath 11, and the deionized water is stored within the processing bath 11. This accomplishes the efficient replacement of the SC-2 solution with the deionized water as the processing liquid within the processing bath 11.

When the concentration of the SC-2 in the processing liquid detected by the concentration sensor 6 reaches a predetermined concentration (the rinsing processing concentration) (Yes in Step S40), the substrate processing apparatus 10e closes the valves 25 and 46 to stop the supply of the deionized water into the processing bath 11 (in Step S41). This completes the rinsing process of the substrates W. Thereafter, the substrate processing apparatus 10e causes the lifter 5 to move up, thereby lifting the substrates W out of the processing bath 11 (in Step S42). A series of processes of the substrates W are completed.

The substrate processing apparatus 10e according to the fifth preferred embodiment ejects the aqueous solution of hydrofluoric acid from the supply nozzles 31 to 34 of the high-speed supply system 3 when supplying the aqueous solution of hydrofluoric acid as an etching solution into the processing bath 11. The substrate processing apparatus 10e ejects the deionized water also from the supply nozzles 31 to 34 of the high-speed supply system 3 until the concentration of the hydrofluoric acid is decreased to the predetermined threshold value when replacing the aqueous solution of hydrofluoric acid with the deionized water as the processing liquid within the processing bath 11. Thus, the substrate processing apparatus 10e is capable of agitating the processing liquid within the processing bath 11 to suppress the unevenness in the concentration of the hydrofluoric acid within the processing bath, thereby causing the etching process to proceed uniformly on the entire major surfaces of the substrates W.

The substrate processing apparatus 10e according to the fifth preferred embodiment, on the other hand, ejects the SC-1 solution or the SC-2 solution from the supply nozzles 41 and 42 of the low-speed supply system 4 when supplying the SC-1 solution or the SC-2 solution as a non-etching solution into the processing bath 11. The substrate processing apparatus 10e ejects the deionized water also from the supply nozzles 41 and 42 of the low-speed supply system 4 when replacing the SC-1 solution or the SC-2 solution with the deionized water as the processing liquid within the processing bath 11. This accomplishes the efficient replacement of the processing liquid within the processing bath 11.

### 6. Other Preferred Embodiments

Although the preferred embodiments according to the present invention have been described hereinabove, the present invention is not limited to the above-mentioned preferred embodiments, but various modifications may be made.

For example, the above-mentioned preferred embodiments show a difference in diameter between the ejection holes of the high-speed supply system 3 and the ejection holes of the low-speed supply system 4. However, only a difference in opening area between the openings of the entire supply systems is required. As an example, there may be a difference in the number of ejection holes between the high-speed supply system 3 and the low-speed supply system 4. Specifically, the number of ejection holes of the high-speed supply system 3 is required only to be smaller than the number of ejection holes of the low-speed supply system 4.

In the above-mentioned preferred embodiments, each of the supply nozzles 31 to 34 of the high-speed supply system 3 ejects the processing liquid in one direction, but may be adapted to eject the processing liquid in a plurality of directions. This further improves the effect of agitating the processing liquid within the processing bath 11 to enable the etching process to proceed more uniformly.

The concentration sensor 6 is provided within the processing bath 11 according to the above-mentioned preferred embodiments, but may be provided in the pipe 71 of the drainage mechanism 7 and the like. In place of the concentration sensor 6, a resistivity meter for measuring the resistivity value of the processing liquid may be provided to detect the concentration of the processing liquid, based on a measurement from the resistivity meter.

In the above-mentioned preferred embodiments, the judgment as to whether the etching process is in progress or not is made, based on the concentration of the liquid chemical component detected by the concentration sensor 6. However, whether the etching process is in progress or not may be judged, based on the time elapsed since the start of the supply of the processing liquid for the replacement of the liquid chemical with the deionized water as the processing liquid within the processing bath 11. The concentration sensor 6 is more preferably used because the use of the concentration sensor 6 allows the accurate judgment as to whether the etching process is in progress or not.

Hydrofluoric acid is used as the liquid chemical component in the first to fourth preferred embodiments described above. However, the liquid chemical component used herein may include ammonia, APM, BHF and the like. The liquid chemical process in the first to fourth preferred embodiments described above is the etching process, but may be other processes such as the process of removing contaminants and the process of peeling a resist film.

During the replacement of the liquid chemical with the deionized water as the processing liquid within the processing bath 11 in the first to fourth preferred embodiments described above, only the low-speed supply system 4 is used to supply the deionized water therethrough into the processing bath 11 after the liquid chemical component concentration is decreased to the predetermined threshold value (in Step S117). Step S17 as described above may be replaced with Steps S17a to S17c shown in FIG. 16. Specifically, after the liquid chemical component concentration is decreased to the predetermined threshold value, the following steps are performed in sequential order: the step of supplying the deionized water through the low-speed supply system 4 (Step 17a); the step of supplying the deionized water through the high-speed supply system 3 (Step S17b); and the step of supplying the deionized water through the low-speed supply system 4 (Step S17c). Thus repeated switching between the low-speed supply system 4 and the high-speed supply system 3 enables the replacement of the liquid chemical with the deionized water to proceed efficiently while removing the liquid chemical remaining on the surfaces of the substrates W by using the deionized water ejected from the supply nozzles 31 to 34 of the high-speed supply system 3. Each of the step of supplying the deionized water through the low-speed supply system 4 and the step of supplying the deionized water through the high-speed supply system 3 may be carried out, for example, for approximately a dozen seconds, and the number of times the switching is repeated is not limited to that shown in FIG. 16. It is, however, desirable that the final step of the repeated switching is the step of supplying the deionized water through the low-speed supply system 4 so that the replacement of the liquid chemical with the deionized water is preferably completed. Similarly, the switching between the low-speed supply system 4 and the high-speed supply system 3 may be done for the supply of the deionized water in Steps S27, S33 and S39 in the fifth preferred embodiment described above.

Of course, all of the preferred embodiments described hereinabove may be implemented in combination, as appropriate.

While the invention has been described in detail, the foregoing description is in all aspects illustrative and not restrictive. It is understood that numerous other modifications and variations can be devised without departing from the scope of the invention.

What is claimed is:

1. A substrate processing apparatus including at least one processing bath for storing a processing liquid therein, said substrate processing apparatus replacing a liquid chemical and deionized water with each other for use as said processing liquid to perform a liquid chemical process and a rinsing process on a substrate within said one processing bath, said substrate processing apparatus comprising:
a first supply part having a relatively small opening for ejecting said processing liquid through said relatively small opening to supply said processing liquid into said processing bath;
a second supply part having a relatively large opening for ejecting said processing liquid through said relatively large opening to supply said processing liquid into said processing bath; and
a controller for controlling the operation of said first and second supply parts supplying said processing liquid,
said controller causing said first supply part to supply said processing liquid while said liquid chemical process is in progress,
said controller causing said second supply part to supply said processing liquid while said liquid chemical process is not in progress.

2. The substrate processing apparatus according to claim 1, further comprising:
a detection part for detecting the concentration of a liquid chemical component in said processing liquid within said processing bath; and
a judgment part for judging whether said liquid chemical process is in progress or not, based on the detected concentration of said liquid chemical component.

3. The substrate processing apparatus according to claim 2, wherein
said first supply part includes a plurality of nozzles divided into a plurality of groups, and
said controller causes said plurality of groups to sequentially eject said processing liquid when said controller causes said first supply part to supply said processing liquid.

4. The substrate processing apparatus according to claim 3, further comprising
an adjustment part for adjusting the concentration of said liquid chemical component in said processing liquid being supplied into said processing bath,
said adjustment part varying the concentration of said liquid chemical component in said processing liquid being supplied into said processing bath toward a target concentration within the range of from a pre-replacement concentration to said target concentration while said liquid chemical process is in progress, said target concentration being a concentration to be reached after the replacement, said pre-replacement concentration being a concentration of said liquid chemical component in said processing liquid within said processing bath prior to the replacement.

5. The substrate processing apparatus according to claim 3, further comprising
a circulating mechanism for collecting said processing liquid used in said processing bath to supply the collected processing liquid into said processing bath while said liquid chemical process is in progress.

6. A method of processing a substrate, said method replacing a liquid chemical and deionized water with each other for use as a processing liquid to perform a liquid chemical process and a rinsing process on the substrate within one processing bath, said substrate processing method comprising the steps of:
(a) ejecting said processing liquid through a relatively small opening to supply said processing liquid into said processing bath while said liquid chemical process is in progress; and
(b) ejecting said processing liquid through a relatively large opening to supply said processing liquid into said processing bath while said liquid chemical process is not in progress.

7. A substrate processing apparatus for performing a liquid chemical process using a liquid chemical and a rinsing process using deionized water on a substrate, said substrate processing apparatus comprising:
a processing bath for storing a processing liquid therein;
a holding part for holding the substrate within said processing bath;
a processing liquid supply part for supplying one of the liquid chemical and the deionized water as the processing liquid into said processing bath;
a detection part for detecting the concentration of a liquid chemical component in the processing liquid stored in said processing bath; and
a controller for controlling said processing liquid supply part,
said processing liquid supply part including a first ejection part having a relatively small opening for ejecting the processing liquid through said relatively small opening into said processing bath, and a second ejection part having a relatively large opening for ejecting the processing liquid through said relatively large opening into said processing bath,
said controller causing said first ejection part to eject the liquid chemical when replacing the deionized water with the liquid chemical as the processing liquid within said processing bath,
said controller causing said first ejection part to eject the deionized water and then causing said second ejection part to eject the deionized water after the concentration detected by said detection part is decreased to a predetermined threshold value when replacing the liquid chemical with the deionized water as the processing liquid within said processing bath.

8. The substrate processing apparatus according to claim 7, wherein:
said first ejection part includes a plurality of nozzles;
said plurality of nozzles included in said first ejection part are divided into a plurality of groups; and
said controller causes said plurality of groups to sequentially eject said processing liquid when said controller causes said first ejection part to eject the processing liquid.

9. The substrate processing apparatus according to claim 8, further comprising
a circulating mechanism for collecting the processing liquid used in said processing bath to supply the collected processing liquid into said processing bath.

10. The substrate processing apparatus according to claim 9, wherein
when replacing the liquid chemical with the deionized water as the processing liquid within said processing bath, said controller causes said first ejection part to eject the deionized water, then causes said second ejection part to eject the deionized water after the concentration detected by said detection part is decreased to the predetermined threshold value, and thereafter causes the ejection of the deionized water from said first ejection part and the ejection of the deionized water from said second ejection part a predetermined number of times.

11. A substrate processing apparatus for performing an etching process using a first liquid chemical, a non-etching process using a second liquid chemical, and a rinsing process using deionized water upon a substrate, said substrate processing apparatus comprising:
a processing bath for storing a processing liquid therein;
a holding part for holding the substrate within said processing bath;
a processing liquid supply part for supplying one of the first liquid chemical, the second liquid chemical and the deionized water as the processing liquid into said processing bath;
a detection part for detecting the concentration of the component of the first liquid chemical in the processing liquid stored in said processing bath; and
a controller for controlling said processing liquid supply part,
said processing liquid supply part including a first ejection part having a relatively small opening for ejecting the processing liquid through said relatively small opening into said processing bath, and a second ejection part having a relatively large opening for ejecting the processing liquid through said relatively large opening into said processing bath,
said controller causing said first ejection part to eject the first liquid chemical when replacing the deionized water with the first liquid chemical as the processing liquid within said processing bath,
said controller causing said first ejection part to eject the deionized water and then causing said second ejection part to eject the deionized water after the concentration detected by said detection part is decreased to a predetermined threshold value when replacing the first liquid chemical with the deionized water as the processing liquid within said processing bath,
said controller causing said second ejection part to eject the deionized water when replacing the second liquid chemical with the deionized water as the processing liquid within said processing bath.
